(19) United States
(12) Patent Application Publication
(10) Pub. No.: US 2004/0105930 A1
(43) Pub. Date: Jun. 3, 2004

(54) Enhancing puffable food products and for production thereof

(75) Inventors: Kazuaki Morii, Sakurai-shi (JP); Kiyoshi Morii, Sakurai-shi (JP); Simpey Kuramoto, Allendale, NJ (US); Roland Abate, Allendale, NJ (US)

Correspondence Address: Stephen B. Salai, Esq., Harter, Secrest & Emery LLP, 1600 Bausch & Lomb Place, Rochester, NY, 14604-2711, US

(73) Assignees: Wynn Starr Flavors, Inc., Allendale, NJ (US); Morii Foods Co., Ltd, Sakurai-shi (JP)

(21) Appl. No.: 10/638,864

(22) Filed: Aug. 11, 2003

Related U.S. Application Data
(63) Continuation-in-part of application No. 10/021,136, filed on Oct. 22, 2001, now Pat. No. 6,645,541.
Application No. 10/021,136 is a continuation-in-part of application No. 09/812,803, filed on Mar. 20, 2001, now Pat. No. 6,461,660.
(60) Provisional application No. 60/235,732, filed on Sep. 27, 2000.
(60) Provisional application No. 60/241,866, filed on Oct. 20, 2000.
(60) Provisional application No. 60/276,374, filed on Mar. 16, 2001.

(51) Int. Cl. A21D 13/00

(52) U.S. Cl. 426/559

(57) ABSTRACT

The present invention relates to a puffable food product suitable for puffing by microwaving, deep fat frying and hot air cooking. The puffable food product can be formed by a method of mixing a starch with water at a temperature and for a time sufficient to at least partially gelatinize the starch, forming the mixture into a sheet and subjecting the sheet to a steam treatment to fully gelatinize the starch. The sheet is then cooled and cut into pellets of a desired shape and the pellets are dried. The inclusion of flavoring or seasonings and the control of pH to improve the puffability is also disclosed.

### CROSS-REFERENCE TO RELATED APPLICATIONS

This application is a continuation-in-part application of, and claims priority from non-provisional U.S. patent application Ser. No. 10/021,136 filed Oct. 22, 2001, which is a continuation in part of non-provisional U.S. patent application Ser. No. 09/812,803, filed on Mar. 20, 2001, and also claims the benefit of U.S. Provisional Patent Application Serial No. 60/235,732, filed Sep. 27, 2000, U.S. provisional Patent Application Serial No. 60/241,866 filed Oct. 20, 2000, and U.S. Provisional Application No. 60/276,374 filed Mar. 16, 2001. The contents of each of the aforementioned non-provisional and provisional applications are incorporated herein by reference.

### STATEMENT REGARDING FEDERALLY SPONSORED RESEARCH OR DEVELOPMENT

Not Applicable.

### REFERENCE TO A “SEQUENCE LISTING”

Not applicable.

### BACKGROUND OF THE INVENTION

1. Field of the Invention

The present invention is directed to puffable food products and methods for forming puffable food products, and more particularly to methods of enhancing the puffing characteristics of food products such as potato, mung bean, wheat, corn, soy beans, rice and rice powder, tapioca, or bean starches and starches from other food products and food products obtained therefrom for puffing by microwave, hot air, or deep fat frying.

2. Background Art

The snack food market includes puffed food products, wherein the puffing can be accomplished by microwaves, hot air or deep fat. It is further contemplated the puffing of the food product can be performed for commercial or wholesale distribution, as well as residential or home puffing.

For example, the market for microwaveable snacks focuses on popcorn which the consumer can easily prepare by “popping” a bag of popcorn immersed in butter flavored oil and salt in the microwave for 2 to 4 minutes. The basis for popping is the retention of moisture in the corn, which “explodes” in the microwave with a popping sound and thereby “gelatinizes” the carbohydrates in an expanded state.

There are many known processes for preparing microwaveable snack products. For example, U.S. Pat. No. 5,108,772 issued to Wilbur (hereinafter referred to as the '772 patent”) discloses microwaveable poppable pellets and their methods of preparation. Normally, the consumer can tell when the product is finished in the microwave oven when the sound of popping ceases. A problem with using puffable pellets in place of popcorn in a microwave snack is the lack of a sound cue to indicate completion of the microwave-heating step because the pellets expand gradually rather than explode, as does popcorn. Thus, a consumer would have to rely on visual cues to determine the completion of the microwave-heating step. The '772 patent solves this problem by providing a pellet having an outer skin or casing of sufficient tensile strength to allow the buildup of internally generated steam pressure. When the pressure is sufficient, the pellet explodes explosively thus giving an audible clue of the termination of the microwave heating step. Thus, the microwave snacks prepared according to the '772 patent resemble that of popcorn kernels. However, the food products prepared from this process are complicated to make and do not have the same desirable characteristics of a normal puffable product.

U.S. Pat. No. 6,083,552 issued to Kershman, et al. (hereinafter referred to as the '552 patent) discloses microwaveable snacks composed of a combination of popcorn and expandable or puffable food pellets. The combination of these two products minimizes scorching and burning of the starched-based puffable component of the mixture.

Also, in general, microwaveable food products are believed to have better puffability when their shapes are round because the corner parts in square shapes tend to remain uncooked. In fact, the '772 patent limits the disclosed pellets to a rounded shape.

Generally, the shapes disclosed in these patents are produced by extrusion, and press molding. If the shaped product is produced by die cutting, i.e., by forming a sheet of the product and cutting out the shape with a die, e.g., in cookie cutter fashion, problems can arise due to material loss. Thus, the material between the die cuts is non-usable.

Therefore, the need exists for a puffable food product that can be puffed by a variety of methods including microwave, hot air or hot fat. In view of health considerations, hot air puffing is advantageous in low-fat diets. The need also exists for a low-fat or non-fat, hot air puffable food product, wherein the food product can include nutraceuticals.

### BRIEF SUMMARY OF THE INVENTION

The present invention includes a method for preparing a food product which can be quickly cooked and expanded by a rapid heating processes, such as microwaving, hot air heating, e.g., by passing heated air at a temperature of about 400-480° F. over the food product, or deep fat frying in oil that has been preheated to a temperature of at least 340 to 345° F. The present food product exhibits excellent puffable characteristics.

As used herein, the term “puffable” means the ability of the product or pieces thereof to expand in volume, usually at least by twofold, within a short time, e.g., from several seconds to less than two minutes, when subjected to rapid heating. The term “piece” or “pellet” herein means a discrete piece of the food product, usually capable of being contained in a bag for sale of distribution. The food product is easily cooked by such rapid heating to obtain a delicious crunchy snack without problems, such as, overcooking or the need to utilize components to provide audible cues as to cooking times, e.g., popcorn kernels.

In addition, the present food product can include nutraceuticals such as vitamins and minerals, thereby providing a nutraceutical fat free puffed snack product.

The present invention provides for the formation of a mixture of starch, water and specific limitations on certain components, wherein the mixture is partially gelatinized to form a dough. The dough is then formed into a sheet and the remaining ungelatinized starch within the sheet is gelatinized. Preferably, the gelatinized sheet is then cooled to below room temperature, whereafter the sheet is pelletized or rendered to provide desired particle (pellet) sizes, and the rendered particles are then dried to a predetermined moisture content.

Generally, the present food product is obtained by first mixing a gelatinizable starch containing only trace amounts of protein with water at a temperature and for a time sufficient to partially gelatinize the starch. The pH of the mixture is then a set within a predetermined range, typically by the addition of edible acids. In addition, desired nutraceuticals can be added to the mixture. The mixture is rendered into a partially gelatinized dough, and the dough is formed into a sheet, and subjected to a steam treatment to completely gelatinize the starch within the dough. The gelatinized sheet can then be cooled below room temperature to reduce moisture content. The cooled sheet is then shaped into pellets by any of a variety of methods, such as die cutting, and the pellets are dried to a moisture content of about 7.5 to 19% by weight.

### BRIEF DESCRIPTION OF THE SEVERAL VIEWS OF THE DRAWING(S)

[Click here and type Brief Description of Drawings]

### DETAILED DESCRIPTION OF THE INVENTION

The present invention includes a method for preparing a food product which can be quickly cooked and expanded by a rapid heating processes, such as microwaving, hot air heating, e.g., by passing heated air at a temperature of about 400-480° F. over the food product, or deep fat frying in oil that has been preheated to a temperature of at least 340 to 345° F. The present food product exhibits excellent puffable characteristics.

As used herein, the term “puffable” means the ability of the product or pieces thereof to expand in volume, usually at least by twofold, within a short time, e.g., from several seconds to less than two minutes, when subjected to rapid heating. The term “piece” or “pellet” herein means a discrete piece of the food product, usually capable of being contained in a bag for sale of distribution. The food product is easily cooked by such rapid heating to obtain a delicious crunchy snack without problems, such as, overcooking or the need to utilize components to provide audible cues as to cooking times, e.g., popcorn kernels.

In addition, the present food product can include nutraceuticals such as vitamins and minerals, thereby providing a nutraceutical fat free puffed snack product.

The present invention provides for the formation of a mixture of starch, water and specific limitations on certain components, wherein the mixture is partially gelatinized to form a dough. The dough is then formed into a sheet and the remaining ungelatinized starch within the sheet is gelatinized. Preferably, the gelatinized sheet is then cooled to below room temperature, whereafter the sheet is pelletized or rendered to provide desired particle (pellet) sizes, and the rendered particles are then dried to a predetermined moisture content.

Generally, the present food product is obtained by first mixing a gelatinizable starch containing only trace amounts of protein with water at a temperature and for a time sufficient to partially gelatinize the starch. The pH of the mixture is then a set within a predetermined range, typically by the addition of edible acids. In addition, desired nutraceuticals can be added to the mixture. The mixture is rendered into a partially gelatinized dough, and the dough is formed into a sheet, and subjected to a steam treatment to completely gelatinize the starch within the dough. The gelatinized sheet can then be cooled below room temperature to reduce moisture content. The cooled sheet is then shaped into pellets by any of a variety of methods, such as die cutting, and the pellets are dried to a moisture content of about 7.5 to 19% by weight.

Detailed Description of the Preferred Embodiment

The food products or pellets prepared by the method of the present invention can include virtually any shape obtainable by die cutting of a sheet, e.g., round, square, triangular, and the like.

The puffable food products prepared by the method of the present invention can be cooked by any type of rapid heating procedure. Typically, these rapid heating procedures include microwaving, hot air, e.g., heating in a hot air device, such as those used for hot air popping of popcorn, deep fat (or oil) frying, as well as microwave. These are all methods, which heat the food product to a high temperature at a relatively high speed, e.g., in a matter of seconds or in less than a minute or two. The inventive food products can also be cooked using other “explosion” processes such as those used in cereal manufacturing, or the like. Regardless of what process is used to cook the food products, the inventive food product still exhibits excellent and puffing characteristics. Further, the expanded food products have very good texture, mouth feel and taste characteristics and can be nutraceutically enhanced.

The present process results in puffable pellets having a moisture content in the range of from about 7% to about 19% by weight. All weights expressed herein are percentage weight based of the total mixture. Preferably, the moisture content of the pellets is from about 8% to about 16% by weight of the pellets. Even more preferably, the moisture content of the pellets is from about 10% to about 15% by weight of the pellets. Most preferably, the moisture content of the pellets is from about 11% to about 14% by weight of the pellets. In yet another preferred embodiment, the moisture content of the pellets is about 12% by weight of the pellets.

Suitable starch includes starch obtained from potatoes, mung beans, wheat, corn, soy beans, rice and rice powers, tapioca, beans. Mixtures of such starches can also be used. Preferably, 100% potato starch is used as the starch. The starch from each, of the above named sources each possesses somewhat different characteristics. Although all are usable in the inventive method, the most preferred starch source is potato starch. Depending on the end product desired, potato starch can be mixed with small amounts of starch from any one or more of the other named starch sources. For example, the different starches provide different textures, and can vary in puffability characteristic somewhat and the skilled worker in this field would have no problem varying the composition to achieve the desired end characteristics.

In a preferred configuration, the starch employed is neither preprocessed, nor partially gelatinized to prior to forming the mixture. Thus, the starch is, at least substantially, ungelatinized prior to formation of the mixture. In addition, the starch preferably has only trace amounts of protein, typically less than 0.1% by weight.

It is contemplated that one or more from the following ingredients can be mixed with the starch and water during the initial mixing phase, not only for the purpose of adding tastes to the resulting puffed food product, but also to provide for better texture and mouth feel when the pellets are fully expanded by rapid heating systems such as microwave ovens, deep fat fryer, and hot air poppers. Certain flavorings have been found to reduce the average size of the resulting air pockets in the expanded or puffed product, which provides a softer mouth feel. In certain configurations, a sufficient amount of flavoring or seasoning is added to provide a reduced air pocket size in the resulting puffed product, as compared to the puffed product in the absence of the flavoring or seasoning.

The flavorings include salt (sodium, potassium, calcium), carbohydrates (such as sugar, whey, corn syrup solids, fructose, vinegar, barbeque seasoning, nacho seasoning, sour cream & onion seasoning, sweet and sour seasoning, sweet seasoning, hot and spicy seasoning, chicken flavor seasoning, savory flavor seasoning, MSG, HVP, Yeast Autolysates, flavor reaction products, east extracts, hvp, spices and vegetable concentrates, flavor solvents (such as such as propylene glycol, triacetin, benzyl alcohol, glycerin, ethyl and propyl alcohol), natural flavors, artificial flavors, GMO free flavors, vegetable and dairy flavored seasonings, and organic flavors.

The mixture preferably has a minimal amount of protein, preferably less than 1% and more preferably less than 0.1% protein.

To provide nutraceutical enhancements, vitamins and minerals (including vitamins A, B₁, B₂, B₃, B₆, B₁₂ C, D, E, folic acid, and niacinamide, iron and zinc), herbs including natural herbs used in herbal medicine, and other healthy nutritional ingredients can be added to the mixture. The nutraceutical enhancements are selected to retain potency after formation of the pellets and subsequent expansion.

The mixture of the starch, water and other ingredients are then heated in any of a variety of methods to effect partial gelatinization of the starch. Typically, a jacket mixer may be used. While the heating temperature used for this step is dependent on the type of starch, i.e., the starch source, generally, the mixture is heated at a temperature of from about 55° C. to 70° C. For potato starch, the mixture of starch and water is heated at a temperature of from about 60.0° C. to 65.0° C. for a time period of from about four to six minutes to effect at least partial gelatinization of the starch. It is best that the starch not be completely gelatinized in this step since the mixture increases in viscosity with increased gelatinization and the mixture must be sufficiently pourable to form into sheet form. To some extent the amount of gelatinization depends on the properties of the particular starch, i.e., the source of the starch.

The partially gelatinized mixture (dough) is then formed into a sheet. The sheet formation is generally accomplished by pouring the partially gelatinized mixture (dough) into, or onto a flat pan or onto a conveyor or roller belt for continuous processing. The thickness of the sheet is generally in the range from about 0.9 cm to 3.0 cm prior to the steam treatment. Preferably the sheet thickness prior to the steam treatment is from about 1.3 cm to 2.7 cm and most preferably from about 1.3 cm to 1.7 m. The thickness of the sheet prior to the steam treatment is not particularly critical, but does effect the thickness of the final product since the die cut pellets are dried after the cutting. Thus, the thickness of the dried pellets corresponding to the above pre-steaming thickness, respectively, would be about 0.5 cm to 2.7 cm, preferably from about 0.8 cm to 2.4 cm and most preferably about 0.8 cm to 1.4 cm.

After the mixture is formed into a sheet, the sheet is subjected to a steam treatment, to effect complete gelatinization of the mixture. The steam treatment is carried out by contacting the sheet with steam for a period of time to produce complete gelatinization. This can be achieved by placing the sheet into a steam oven or other procedures well known in the art. The steam treatment can be carried out at atmospheric pressure. The amount of time required for the steam treatment depends on the thickness of the sheet and source of the starch. Generally, the steam treatment is carried out for about one to seven minutes at a steaming temperature of about 95 to 100° C. Longer steaming can occasionally result in producing an unevenness in the surface of the sheet, e.g., craters may form in the surface. Preferably, the steaming time is about one to five minutes for a continuous or in-line process and about three to six minutes for a batch steamer. The most preferred time required for steaming is from about three to five minutes. However, the steaming process may be carried out from 6 to 6 minutes to as much as 8 to 10 minutes, before undesirably deformation of the sheet surface occurs. At a minimum, the steaming process is selected to provide at least substantially full gelatinization of the starch, and at a maximum, the steaming process is terminated prior to deforming the surface of the sheet by the formation of craters or wrinkles on the surface of the sheet.

After the steam treatment, the sheet is cooled. It has been found that cooling the gelatinized sheet, prior to rendering into pellets (particles), increases the efficiency of the rendering process. Preferably, the gelatinized sheets are cooled for less than 24 hours at a temperature of 5 to 10° C. It is believed this reduced temperature results in a lower moisture content of the particles prior to the rendering and subsequent drying process. Specifically, for sheets that have been cooled, the subsequent drying process necessary to obtain the desired moisture content in the final pellets is reduced.

It has further been determined that cooling the gelatinized sheet at room temperature for 24 hours, results in a higher moisture content, as compared to sheets cooled at the lower temperature, and thus results in less efficient cutting or rendering of the gelatinized sheet to form the pellets. In addition, the required drying time is increased. Thus, the gelatinized sheets are cooled to below room temperature but above freezing for time that does not dry the sheet below the target moisture content for rendering. The moisture content for rendering the sheet is between 30% and 50%, preferably, between 35% and 45%. It has been found that a sheet with 30% or less moisture becomes brittle, or a little too hard for predictable cutting, while a sheet with 45% or higher moisture remains sufficiently pliable for cutting.

It has been determined that cooling the sheets at 5 to 10° C. for more than 24 hours has a negative impact on the expandability or puffing of the resulting pellets. Cooling times of less than 24 hours at a temperature of approximately 5 to 10° C. still provides good expansion response of the pellets.

It is also understood the gelatinized sheet can be alternatively dried prior to forming the pellets, wherein the drying can be accomplished by air drying or heating. It is important that the sheet be dried only to the extent such that it can be cut or formed (rendered) into the desired pellet shape. If the sheet is dried too much, the sheet may become too brittle so that when it is shaped, as by die cutting, the pellets will fracture. The degree of dryness is adjusted to achieve the desired result, i.e., size and shape of the pellets. Usually, the finished product in pellet form has a moisture content of from 7.5 to 19% by weight. More preferably, the moisture content is from about 11% to about 14% by weight of the pellet. In a further preferred configuration, the moisture content of the pellet is about 12% by weight of the mixture.

The product of the present invention exhibits excellent puffing characteristics when rapidly heated, e.g., in a microwave oven, hot air popper or when subjected to deep fat frying. In addition, depending on the starch source and the amount and type of seasoning added in accordance with the invention, one may obtain an audible popping or cracking sound when the pellets are being heated so that an audible signal is provided to determine when the heat time is finished. Also, if the pellets are packaged in a microwave-cooking bag, upon heating of the bagged product, the bag expands and the consumer can determine when the cooking is done by visual observation of the cessation of the expansion of the bag.

The resulting puffed pellets exhibit air pockets throughout the expanded product. It is found that smaller air pockets provide a softer mouth feel, while larger pockets tend to result in a crunchier or harder product. In addition, the air pockets are generally a more uniform size distribution and smaller for those doughs that include a flavoring, such as those set forth above, compared to the same products but without the flavorings. Preferably, the median size of the resulting air pockets is approximately 1.2 mm in diameter, or less.

As set forth in the examples below, it has been found that the pellets will normally expanded oil at 350° F. within approximately 25 seconds, depending upon the size of the pellet. For the same size pellets and 400° F. oil, the pellets typically expand within 15 seconds, while some pellets will fully expand within 10 seconds. Specifically, and has been found that generally square pellets of the dimension of 1.5 cm fully expand within 15 seconds at 400° F. oil.

The present invention thus provides for a puffable food product without requiring leavening, protein or maltodextrins. Thus, certain embodiments of the puffable food product are free of leavening, protein or maltodextrins.

The following examples are provided to assist in further understanding the present invention. The particular materials and conditions employed are intended to be further illustrative of the invention and are not limiting upon the reasonable scope thereof.

### EXAMPLE 1

A puffable, including microwaveable food product of the present invention was prepared according to the following procedure. A mixture of 300 grams (g) of potato starch, 20 grams of a salt and vinegar seasoning, and 320 cc of heated water was prepared by using a jacket mixer.

The salt and vinegar seasoning had the composition shown in Table 1.

TABLE 1

| Ingredient | Weight % of the Composition |
|---|---|
| Maltrin | 50.0 |
| Salt | 29.0 |
| Essicum Vinegar | 15.0 |
| Vinegar Powder | 3.0 |
| Citric Acid | 3.0 |

The mixture was then poured through a belt roller and sheets having a thickness of 2.0±0.7 mm were obtained. The sheets were then subjected to a steam process at 95 to 100° C. for five to seven minutes to fully gelatinize the starch. The sheets were then cooled at 2 to 10° C. for two hours. That is, the sheets were immersed in an environment having a temperature above freezing but below room temperature. After cooling, the sheets were die cut to form round pieces of 20 to 40 mm in diameter. The cut pieces were further dried to have a moisture of 8 to 15% at a thickness of 2.0±0.7 cm. The potato starch based food products prepared in this example had round shapes 2 to 4 cm in diameter and 1.5 cm×2.0 cm rectangular shapes.

The potato food products prepared by this procedure had enhanced puffability and deep fat frying puffing characteristics. In particular, deep fat frying at 345° F. or at a higher temperature such as that used in frying french fries results in a unique texture and mouth feel. The inclusion of seasonings such as spices, salt, sugar, etc. greatly enhances the puffability of the starch based formulations.

Furthermore, the rectangular shaped potato food products prepared in this example had enhanced puffability and hot air puffing characteristics. The inclusion of seasonings such as spices, salt, sugar, and the like greatly enhances the hot air puffability of the starch based formulations.

### EXAMPLE 2

A puffable, including microwaveable, food product of the present invention was prepared according to the following procedure.

A mixture of 190 grams of potato starch and 190 cc of water was prepared by using a jacket mixer for four to six minutes at temperatures from 55 to 70° C. A preferable temperature to prepare this mixture is 60° C.±2° C.

The mixture (dough) was then poured through a belt roller and sheets were formed. The sheets were then subjected to a steam process at 950 to 100° C. for five to seven minutes to fully gelatinize the starch. The sheets were then cooled at 2 to 10 C for two hours. After cooling, the sheets were die cut to form square, rectangular and round pieces. The cut pieces were further dried to have a moisture content of 8 to 16%, preferably 12 to 14%, at thickness of 0.4 to 2.0 cm, preferably 0.9 to 1.4 cm, in a drying room at 40° to 45° C. for 2 to 2½ hours. The potato food products prepared by this procedure had enhanced puffability and deep fat frying puffing characteristics.

### EXAMPLE 3

A puffable, including microwaveable, food product of the present invention including barbecue seasoning was prepared by the procedure described in Example 2 wherein barbecue seasoning was added within the matrix of the ungelatinized potato starch and water. The barbecue seasoning had the composition shown in Table 2.

TABLE 2

| Ingredient | Weight % of the Composition |
|---|---|
| Sugar | 20.0 |
| Salt | 20.0 |
| HVP | 10.0 |
| Spices | 50.0 |

The barbecue seasoned food products had outstanding puffability. Inclusion of 5 to 20% of a seasoning did not impede the snack formation process of sheeting, forming and cutting, and drying to 15% moisture (water)±3% facilitated the process. The microwaved food snacks had improved mouth feel and texture.

### EXAMPLE 4

A puffable, including microwaveable, food product of the present invention was prepared using potato starch and water, according to the procedure described in Example 2. In particular, a mixture of 190 grams of potato starch and 190 cc of water having a temperature of 60° C. was prepared by using a jacket mixer for four to six minutes.

Using potato starch did not impede the overall process of forming pellets. Also, adding heated water having a temperature of 60° C. to the potato starch and mixing the materials using a jacket mixer created a fully mixed composition which easily and smoothly was formed into a sheet (referred to herein as “sheeting”). The sheets had a moisture content between 10% to 15% and the dried pellets were almost transparent, strong and not easily breakable.

If potato starch, though, was mixed with 80° C. water, the mixture would become extremely high in viscosity and thus impedes the sheeting process. Therefore, it is very important to understand the gelatinization temperature to fully gelatinize the compound and in the case of potato starch, the gelatinization temperature is generally in the range of from about 55° to about 65° C.

The dried pellets obtained by the procedure described in this example were further tested in a microwave. In particular, ninety die cut 1.5 cm×1.5 cm square pellets were placed in a microwaveable bag, sealed and microwaved using a Panasonic 1,050 Watt (hereinafter “W”) microwave. After approximately 5 to 10 seconds, a popping sound was heard. As the puffable pellets expanded, not only was a puffing sound heard, but also the popcorn bag inflated as the moisture from the pellets lifted up the bag. After about 45 seconds, the popping sound ceased and the microwaveable bag was fully inflated. The bag was opened following the same procedures used when opening well known microwave popcorn products and unique, uniformly puffed potato starch products with outstanding expansion were obtained which in this case were totally free of fat.

### EXAMPLE 5

The same process as described in Example 4 was used to prepare a puffable, including microwaveable food product, however, corn starch was used instead of potato starch. In particular, 190 g corn starch was mixed with 190 cc water heated to a temperature of 75° C., which is the gelatinization temperature of corn starch. The mixture of corn starch and water was formed into a sheet and exhibited outstanding sheetability. After being steamed, cooled, die cut and dried, the pellets obtained were not easily breakable.

Then, ninety of these die cut 1.5 cm×1.5 cm square shaped pellets were placed in a standard microwaveable bag, sealed and microwaved using a Panasonic 1,050 W microwave. The corn starch based pellets did not expand uniformly and resulted in undesirable starch material which was part unpuffed and part burned. Furthermore, in the pellets, which were cooked and not burned, the expandability was not as good as that obtained using potato starch as the base food product. Also, the texture of the microwaved corn starch based pellets was hard.

### EXAMPLE 6

A puffable, including microwaveable, food product of the present invention was prepared according to the procedure described in Example 4, however, wheat flour starch was used instead of potato starch. In particular, 190 g of wheat flour was mixed with 190 cc of water having a temperature of 60° C. The mixture, though, was not suitable for sheeting. Further, after adding additional water, it was still difficult to sheet. The mixture was then manually sheeted and steamed and had an undesirable surface with many craters. After being die cut to form 1.5 cm×1.5 cm square shape pellets, the die cut pieces were dried to have a 10-15% moisture content. The pellets were not easily breakable, though, they were inconsistent in their thickness.

Then, ninety of these die cut 1.5 cm×1.5 cm square shaped pellets were placed in a standards microwaveable bag, sealed and microwaved using a Panasonic 1,050 microwave. The wheat flour based pellets did not expand uniformly and resulted in an undesirable flour material, which was part burned and part unpuffed. Further, in the pellets, which were cooked, the expandability was not as good as that obtained using potato starch as the base food product. Also, the texture of the microwaved wheat flour based pellets was hard.

### EXAMPLE 7

A puffable, including microwaveable, food product of the resent invention was prepared according to the procedure described in Example 4, however, tapioca starch was used instead of potato starch. In particular, 190 g of tapioca starch was mixed with 190 cc of water having a temperature of 70° C. The mixture of tapioca starch and water, though, was not found to be suitable for sheeting. The mixture was then manually sheeted and steamed, cooled, die cut, and dried. The pellets obtained were not easily breakable.

Then, ninety of these die cut 1.5 cm×1.5 cm square pellets were placed in a standard microwaveable bag, sealed and microwaved using a Panasonic 1,050 W microwave. After about 45 seconds, the popping sound ceased and the microwaveable bag was somewhat inflated. The popping sound was not as loud as what had been heard using potato starch as the primary food ingredient in Example 4. The bag was opened using the same procedures used when opening well known popcorn bags, and unique, uniformly puffed products with outstanding expansion were obtained.

### EXAMPLE 8

A puffable, including microwaveable, food product of the present invention was prepared according to the procedure described in Example 4, however, waxy corn was used instead of potato starch. In particular, 190 g of waxy corn was mixed with 190 cc of water heated to its gelatinization temperature of 70° C. The mixture of waxy corn and water was not suitable for sheeting. The mixture was then manually sheeted and then steamed, cooled, die cut and dried. The pellets obtained were not easily breakable.

Then, ninety of these die cut 1.5 cm×1.5 cm square pellets were placed in a standard microwaveable bag, sealed and microwaved using a Panasonic 1,050 W microwave. After approximately 5-15 seconds, a popping sound was heard. As the puffable pellets expanded, not only was a puffing sound heard, but the popcorn bag also inflated as the moisture from the pellets lifted up the bag. Further, after about 45 seconds, the popping sound ceased and the microwaveable bag was fully inflated. The bag was opened using the same procedures used when opening well known popcorn bags and unique, uniformly puffed products with outstanding expansion were obtained.

### EXAMPLE 9

A puffable, including microwaveable, food product of the present invention was prepared according to the procedure described in Example 4, however, a combination of potato starch and tapioca starch was used instead of only potato starch. In particular, 95 g of potato starch and 95 g of tapioca starch was mixed with 190 cc of water heated to a temperature of 60° C., which is the gelatinization temperature of potato starch. The mixture of potato starch, tapioca starch and water was not so much suitable for sheeting. However, by mixing the two food products, the sheeting process became easier than what was found to be difficult as described in Example 6, but not as smooth as described in Example 2. The mixture was then sheeted and then steamed, cooled, die cut and dried. The pellets obtained were not easily breakable.

Then, ninety of these die cut 1.5 cm×1.5 cm square pellets were placed in a standard microwaveable bag, sealed and microwaved using a Panasonic 1,050 W microwave. After approximately 10-25 seconds, a popping sound was heard. As the puffable pellets expanded, not only was a puffing sound heard, but the popcorn bag also inflated as the moisture from the pellets lifted up the bag. Further, after about 45 seconds, the popping sound ceased and the microwaveable bag was fully inflated. The bag was opened using the same procedures using when opening well known popcorn bags and unique, uniformly puffed products with somewhat outstanding expansion were obtained. However, although the pellets seemed to have expanded uniformly, there was some pellets that still had a tiny portion uncooked inside.

### EXAMPLE 10

A puffable, including microwaveable food product of the present invention was prepared according to the procedure described in Example 4, however, a combination of potato starch and cornstarch was used instead of only potato starch. In particular, 152 g of potato starch and 32 g of cornstarch was mixed with 190 cc of water heated to a temperature of 60° C., which is the gelatinization temperature of potato starch. The mixture of potato starch, corn starch and water was somewhat suitable for sheeting while potato starch and corn starch had outstanding sheetability as described in Example 4 and Example 5. After mixture was sheeted, it was steamed, cooled, die cut and dried. The pellets obtained were not easily breakable.

Then, ninety of these die cut 1.5 cm-1.5 cm square pellets were placed in a standard microwaveable bag, sealed and microwaved using a Panasonic 1,050 W microwave. After about 45 seconds, the pellets were cooked. The bag was opened following the same procedures used when opening well known popcorn bags and unique, uniformly puffed products were obtained. Although the pellets seemed to have expanded uniformly, the pellets expanded somewhat less than the 100% potato starch based pellets and the texture of the pellets was somewhat hard.

Table 3 below summarizes the results from the Examples 4 through 10 as results of some other combinations of food products which were tested to the same procedure used in Examples 4-10.

TABLE 3

| Ex- | | Water | | | |
|---|---|---|---|---|---|
| ample | | Amount | Water | Sheet- | Puff- |
| Number | Starch Source | (cc) | Temp. | ing | ability |
| 4 | Potato Starch (190 g) | 190 | 60 | 1 | 1 |
| 5 | Corn Starch (190 g) | 190 | 75 | 1 | 3 |
| 6 | Wheat Flour (190 g) | 190 | 60 | 4 | 3 |
| 7 | Tapioca Starch (190 g) | 190 | 70 | 3 | 1 |
| 8 | Waxy Corn (190 g) | 190 | 70 | 4 | 1 |
| 9 | Potato Starch (190 g) + | 190 | 60 | 3 | 2 |
| | Tapioca | | | | |
| 10 | Starch (190 g) | 190 | 60 | 2 | 2 |
| N/A | Potato Starch (152 g) + | 190 | 70 | 3 | 2 |
| | Corn Starch | | | | |
| N/A | (38 g) | 190 | 60 | 3 | 2 |
| N/A | Potato Starch (190 g) | 190 | 80 | 3 | 2 |
| N/A | (190 g) | 190 | 60 | 3 | 2 |
| N/A | Potato Starch (190 g) | 190 | 70 | 3 | 2 |
| N/A | (190 g) | 190 | 80 | 2 | 2 |

* Sheeting = 1 being Outstanding and 4 being Extremely Bad
* Puffability = 1 being Outstanding and 3 being Extremely Bad

When microwaveable food products are heated in a microwave, the combination of air and moisture within the food product generates pressure that causes the food product to expand. Upon expansion, it is important for the food product to have proportional streatchability with the generated pressure for expansion.

From Table 3 it is readily apparent that potato starch, tapioca starch and waxy corn have outstanding expandability as well as other common properties. In particular these food products have a relatively high percentage of amylopectin, lower temperatures for gelatinization, higher swelling power when gelatinized and higher peak viscosity when gelatinized.

Further, based on the above examples, it is apparent that in order to obtain excellent puffing characteristics, it is important to create microwaveable food products that are completely gelatinized. Complete gelatinization allows the starch particles to spread throughout the compound and thus results in clear, almost transparent pellets when no flavors are added. Forming a completely gelatinized pellet results in homogeneously distributing the moisture throughout the entire pellet and superior uniform puffability.

When comparing potato starch to other food starches, potato starch has the lowest gelatinization temperature. Tapioca and waxy corn also have relatively lower gelatinization temperature that will result in complete gelatinization.

When a completely gelatinized and aged pellet is created and microwaved, uniformly distributed moisture within a pellet heats up to generate pressure for expansion. The base food product having higher peel viscosity and higher swelling power in nature, stretches greater in proportion to the pressure generated by microwave heating. Although there is a higher percentage of amylopectin in tapioca and waxy corn compared to potato starch, potato starch has higher peak viscosity as well as the swelling power of amylopectin.

It has also been found that potato starch and corn starch are preferable food products from a processing standpoint as far as mixing, sheeting, steaming, cooling, die cutting and driving while other food products endured difficulties in one or more of the processes required during the production of pellets. Corn starch, though, resulted in an undesirable starch material which was part burned and part unpuffed and the corn starch based pellets that were cooked and not burned had very poor expandability.

Accordingly, 100% potato starch has the most preferred characteristics from both a processing and puffability standpoint and thus potato starch is the most preferred primary food product for use in preparing the puffable, including microwaveable expandable food products. In addition, food products which are not shown in Table 1 such as mung beans, rice powders, etc., also did not show characteristics superior to potato starch.

The potato starch used in the above examples to obtain microwaveable food products had the following characteristics as shown below in Table 4.

TABLE 4

| | |
|---|---|
| Appearance | White Powder |
| Odor | None |
| Crude Protein | 0.1% or less |
| Acidity | 5.5-8.5 |
| Moisture | Less than 18% |
| PH | 5.5-6.5 |
| Brabender Amylograph Reading (4% | 1100 BU-1400 BU |
| water) | |
| Gelatinization Temperature | 61°-63° C. |
| % of Ash | 0.2% or less |

The present invention also contemplates using starches from one or more sources. For example, if potato starch is the primary food product, starch from a second source can be admixed. However, because the differences in the gelatinizing temperatures of potato starch and a different starch may result in unstable gelatinization characteristics when mixed, the amount of the second is preferably less than 50% by weight of the amount of potato starch. Otherwise, the second starch may impede all or part of the process including mixing, gelatinizing, sheeting, steaming, forming alpha lattices, cooling, die cutting, drying and puffing. Preferably, the amount of the second starch or combination of starches added to potato starch is in the range from about less than 20% by weight of the amount of potato starch.

Furthermore, although Example 4 illustrates solutions to expand food products in a uniform manner with a popping sound, the present invention also discloses methods of obtaining rather improved puffing characteristics including preferred texture, mouth feel and taste by adding one or more seasonings with the matrix of a food product such as potato starch as discussed above in the Summary of the Invention and shown below in Examples 11-16.

### EXAMPLE 11

A puffable, including microwaveable, food product of the present invention including barbecue seasoning was prepared in the same manner as the procedure described in Example 3 above. In particular, a mixture of 190 grams of potato starch and 190 cc of water heated to a temperature of from 55 to 70° C. was prepared using a jacket mixer for four to six minutes. The sheets formed from the mixture were steamed and cooled and then pre-dried die cut to form 1.5 cm×1.5 cm square shaped pieces. Then, after these pellets were dried to have a 13%±1.5% moisture content, the size of these square shaped pellets shrank to 1.2-1.4 cm×1.4 cm.

Ninety of these dried pellets were then placed in a standard microwaveable bag and microwaved using a Panasonic 1,050 W microwave. After approximately 5-10 seconds, a popping sound was heard. As the puffable pellets expanded, not only was a puffing sound heard, but the microwaveable bag also inflated as the moisture from the pellets lifted up the bag. Further, after about 45 seconds, the popping sound ceased and the microwaveable bag was inflated. The bag was opened following the same procedures used when opening well known popcorn bags and unique, uniformly puffed products were obtained. The final puffed products had outstanding microwaveability characteristics including improved mouth feel and texture in addition to the added barbecue taste.

### EXAMPLE 12

A puffable, including microwaveable, food product of the present invention including chicken seasoning was prepared in the same manner as the procedure described in Example 3 above except that chicken seasoning was added to the matrix of the potato starch instead of barbecue seasoning. The chicken seasoning had the composition shown in Table 5:

TABLE 5

| Ingredient | Weight % of the Composition |
|---|---|
| Maltrin | 40 |
| Chicken Dripping Flavor | 60 |

The sheets formed from the mixture of potato starch and water wherein the matrix of the potato starch included the chicken seasoning, were steamed and cooled and then pre-dried die cut to form 1.5 cm×1.5 cm square shaped pieces. Then, after these pellets were dried to obtain a 13%±1.5% moisture content, the size of these square pellets shrank to 1.2-1.4 cm×1.2-1.4 cm.

Ninety of these dried pellets were then placed in a standard microwaveable popcorn bag and microwaved using a Sanyo 1,200 W microwave. After approximately five to ten seconds, a popping sound was heard. As the puffable pellets expanded, not only was a puffing sound heard, but the popcorn bag also inflated as the moisture from the pellets lifted up the bag. Further, after about 40 seconds, the popping sound ceased and the microwaveable bag was fully inflated. The bag was opened following the same procedures used when opening well known popcorn bags and unique, uniformly puffed products were obtained. The final puffed products had outstanding microwaveability characteristics including improved mouth feel and texture in addition to the added taste of chicken.

It has also been found that including chicken dripping and fried chicken flavors within the starch matrix and deep fat frying the pellet results in finished goods that taste similar to fried chicken skins. The taste and texture somewhat resembles that of “Pork Rinds,” except in this case, they would be called “Natural Chicken Rinds.”

### EXAMPLE 13

A puffable, including microwaveable, food product of the present invention including sour cream and onion seasoning was prepared in the same manner as the procedure described in Example 3 above except that sour cream and onion seasoning was added to the matrix of the potato starch instead of barbecue seasoning. The sour cream and onion seasoning had the composition shown in Table 6.

TABLE 6

| | Weight % of the |
|---|---|
| Ingredient | Composition |
| Whey Powder | 28 |
| Salt | 15 |
| NFDM | 10 |
| Buttermilk Powder | 10 |
| Sour Cream Powder | 10 |
| Citric Acid | 1 |
| Whey PTX | 5 |
| Flavor | 40 |

The sheets formed from the mixture of potato starch and water wherein the matrix of the potato starch included the sour cream and onion seasoning, were steamed and cooled and then pre-dried die cut to form 1.5 cm×1.5 cm square shaped pieces. Then, after these pellets were dried to obtain a 13%±1.5% moisture content, the size of these square shaped pellets shrank to 1.2-1.4 cm×1.2-1.4 cm.

Seventy of these dried pellets were placed in a standard microwaveable popcorn bag and microwaved using a Westinghouse 850 W microwave. After approximately 5-10 seconds, a popping sound was heard. As the puffable pellets expanded, the popcorn bag inflated as the moisture from the pellets lifted up the bag. Further, after about 50 seconds, the microwaveable bag was fully inflated. The bag was opened following the same procedures used when opening well known popcorn bags and unique, uniformly puffed products were obtained. The final puffed products had outstanding microwaveability characteristics including improved mouth feel and texture in addition to the added taste of sour cream and onion.

### EXAMPLE 14

A puffable, including microwaveable, food product of the present invention including sour cream and onion seasoning was prepared in the same manner as the procedure described in Example 3 above. The sheets formed from the mixture of potato starch and water wherein the matrix of the potato starch included the barbecue or sour cream and onion seasoning, were steamed and cooled and then pre-dried die cut to form 3.0 cm×8.0 cm square shaped pieces. Then, after these pellets were dried to obtain a 13%±1.5% moisture content, the size of these square shaped pellets shrank to 1.2-1.4 cm×1.2-1.4 cm.

Forty of these dried pellets were then laced in a microwaveable bag, sealed, and microwaved using a General Electric 600W microwave. After approximately 5-10 seconds, a popping sound was heard. As the puffable pellets expanded, not only was a puffing sound heard, but the popcorn bag also inflated as the moisture from the pellets lifted up the bag. Further, after about 55 seconds, the popping sound ceased and the microwaveable bag was fully inflated. The bag was opened following the same procedures used when opening well known popcorn bags and unique, uniformly puffed products were obtained. The final puffed products had outstanding microwaveability characteristics including improved mouth feel and texture in addition to the added barbecue or sour cream and onion taste.

### EXAMPLE 15

A puffable, including microwaveable, food product of the present invention including barbecue seasoning was prepared in the same manner as the procedure described in Example 3 above. The sheets formed from the mixture of potato starch and water wherein the matrix of the potato starch included the barbecue seasoning, were steamed and cooled and then pre-dried die cut to from 3.0 cm×8.0 cm square shaped pieces. Then, after these pellets were dried to obtain a 13%±1.5% moisture content, the size of these square shaped pellets shrank to 1.2-1.4 cm×1.2-1.4 cm. These microwaveable pellets were then placed in a hot air popping machine having a set temperature of 480° F. with adjusted air flow to keep the pellets agitated. The results with respect to expansion were outstanding. Some of the pellets having sour cream and onion seasoning obtained in Example 13 were also tested using a hot air popper having a temperature set to 415° F. and the pellets having sour cream and onion seasoning also had outstanding expansion. The expansion of the puffed pellets prepared using a hot air popper was greater than the size of puffed pellets prepared using a microwave and the puffed food products prepared using a hot air popper had outstanding texture and mouth feel and a taste slightly different from that obtained through microwave heating.

### EXAMPLE 16

A puffable, including microwaveable, food product of the present invention including barbecue seasoning was prepared in the same manner as the procedure described in Example 3 above. The sheets formed from the mixture of potato starch and water wherein the matrix of the potato starch included the barbecue seasoning, were steamed and cooled and then pre-dried die cut to form 3.0 cm×8.0 cm square shaped pieces. Then, after these pellets were dried to obtain a 13%±1.5% moisture content, the size of these square shaped pellets shrank to 1.2-1.4 cm×1.2-1.4 cm. These pellets were then deep fat fried using a fryer wherein the temperature of oil was set at 345° F. The expansion results were outstanding. The expansion was greater than the size of puffed pellets prepared using a microwave as described in Example 14 and those puffed using a hot air popper as described in Example 15. In addition, the puffed food products had outstanding texture and mouthful and a taste slightly different from that obtained through microwave heating and hot air popping.

### EXAMPLE 17

A puffable food product of the present invention was prepared according to the following procedure.

A mixture of 180 grams of potato starch and 180 cc of water was prepared by using a jacket mixer for 4 to 6 minutes at temperatures from 55 to 65° C. A preferable temperature to prepare this mixture is 60° C.±2° C. The mixture (dough) was then poured though a belt roller and sheets were formed. The sheets were then subjected to a steam process at 95 to 100° C. for 5 to 7 minutes to form alpha lattices. The sheets were then cooled at 2 to 10° C. for 2 hours. The cooked sheets having moisture content above 16% but below the moisture content upon gelatinization. After cooling, the sheets were die cut to form square, rectangular and round pieces (pellets). The pellets were further dried to have a moisture content of 8 to 16%, preferably 12 to 14%, at thickness of 0.4 to 2.0 cm, preferably 0.6 to 1.2 cm, in a drying room at 40 to 45° C. for 2 to 2½ hours.

Although the potato based food products were prepared in square, rectangular and round shapes, pellets can be cut in any other shape such as the shape of French fries, fried potatoes, swirl or helical, curly shapes, and the like.

The pellets prepared by this procedure had a pH below 7.0, and fully expanded within 15 seconds in oil heated at 400° F. (204° C.).

As used herein, the term “fully expanded” means the pellets expand to their maximum amount, and are fully cooked, without a remaining uncooked or hard center.

### EXAMPLE 18

A puffable food product according to the present invention was prepared according to the following procedure.

A mixture of 180 grams of potato starch, 218 cc of heated water, and the following ingredients were prepared by using a jacket mixer for 4 to 6 minutes at water temperatures from 55 to 65° C.:

| Ingredient | Amount |
|---|---|
| Jalapeno Flavor | 11.70 g |
| Salt & Vinegar Flavor | 5.40 g |
| Whey | 18.00 g |
| Salt | 2.70 g |

A preferable temperature to prepare this mixture is 60° C.±2° C. (i.e. temperature of heated water). The partially gelatinized mixture (dough) was then poured though a belt roller and sheets were formed. The sheets were then subjected to a steam process at 95 to 100° C. for 5 to 7 minutes to form alpha lattices. The sheets were then cooled at 2 to 10° C. for 2 hours. After cooling, the sheets were die cut to form square, rectangular and round pieces. The cut pieces were further dried to have a moisture content of 8 to 16%, preferably 12 to 14%, at thickness of 0.4 to 2.0 mm, preferably 0.6 to 1.2 mm, in a drying room at 40 to 45° C. for 2 to 2½ hours.

Although the potato starch based food products were prepared in square, rectangular and round shapes, the food products can be cut in any other shape such as the shape of French fries, fried potatoes, curly shapes, and the like.

The potato pellets prepared by this procedure had a pH of between 4 to 7, and fully expanded within 15 seconds in oil heated at 400° F. (204° C.) and within 25 seconds in oil heated at 350° F. Furthermore, the flavored pellets were fully expanded within 45 seconds by hot air, wherein hot air temperature was at 375-400° F.

Although, the pellets produced through steaming process as described in Example 17 and Example 18 both fully expanded in short time, the product with flavorings had a superior texture and mouth feel. The plain pellets (without the Jalapeno, and Salt & Vinegar flavorings) had larger air holes within the puffed product, when compared to the air holes within the puffed flavored food product. That is, flavorings with the flavor included resulted in smaller air holes throughout the expanded product which provides a softer mouth feel suitable for snacking.

### EXAMPLE 19

Following the same procedure as described in the previous two examples, the puffable food product was prepared with inclusion of the following ingredients.

A mixture of 162 grams of potato starch, 13 g of tapioca starch, 5.4 g of waxy maze and 188 cc of heated water, and the following ingredients were prepared by using a jacket mixer for 4 to 6 minutes at water temperatures from 55 to 65° C.:

| Ingredient | Amount |
|---|---|
| Maltodextrin | 6.48 g |
| Salt (Sodium Chloride) | 1.73 g |

The food product prepared by this procedure had a pH of less than 7 and greater than 4, and fully expanded within 15 seconds in oil heated at 400° F. (204° C.) and within 25 seconds in oil heated at 350° F. Furthermore, the flavored pellets were fully expanded within 45 seconds by hot air, wherein hot air temperature was at 375-400° F.

### EXAMPLE 20

Following the same procedure as described in the previous examples, the puffable food product was prepared with inclusion of the following ingredients.

A mixture of 162 grams of potato starch, 12.96 g of tapioca starch, 5.4 g of waxy maze and 188.57 cc of heated water, and the following ingredients were prepared by using a jacket mixer for 4 to 6 minutes at water temperatures from 55 to 65° C.:

| Ingredient | Amount |
|---|---|
| Maltodextrin | 6.48 g |
| Salt (Sodium Chloride) | 1.73 g |
| Powdered Cheese Flavor | 25.90 g |

The food product prepared by this procedure had a pH of between 4 and 7, and fully expanded within 15 seconds in oil heated at 400° F. (204° C.) and within 25 seconds in oil heated at 350° F. Furthermore, the flavored potato pellets were fully expanded within 45 seconds by hot air, wherein hot air temperature was at 350-400° F.

### Findings and Interpretations from Examples 17-20

The puffable product disclosed in examples 17-20 fully expanded within 15 seconds in oil heated at 400 F (204° C.). In contrast to prior puffable products, the reduced time of the present invention causes a greater percentage of puffing in a reduced time, thereby allowing removal of heat at an earlier time so as to reduce potential for burning or charring of the product. This reduced puffing time is believed to be less than is provided in the prior art.

The size of the resulting air pockets after expansion is different between plain (unflavored) pellets and flavored pellets. In general, the flavored pellets tend to have smaller air pockets providing rather suitable texture for snacking.

It has been found that plain pellets tend to expand more vertically while flavored pellets expand more horizontally. That is, for a plain pellet from a sheet of a initial thickness, tends to expand (increase) along the thickness of the sheet, in the vertical direction.

In addition to the findings from the Examples 17-20, it has been found that adding only salt to the starch-water matrix causes the pellets to expand horizontally. That is, for a pellet from a sheet having a given thickness, the addition of the salt tends to cause the air pockets to expand generally perpendicular to the thickness of the sheet. However, only adding salt results in relatively larger air pockets which are not desirable for snacking, as the large pockets do not provide a satisfactory mouth feel.

Furthermore, it has been found that adding additional ingredients to the salt-starch matrix prior to mixing would reduce the size of air pocket upon expansion. Specifically, adding whey or sugar with starch and salt prior to mixing results in better puffing characteristics and superior mouthfeel as compared to only starch (plain) or pellets with only salt added to the starch mixture.

### EXAMPLE 21

Following the same procedure as described in the previous examples, the puffable food product was prepared with inclusion of the following ingredients.

A mixture of 126 grams of potato starch, 36 grams of corn starch, 18 grams of tapioca starch, 212 cc of heated water, and the following ingredients were prepared by using a jacket mixer for 4 to 6 minutes at water temperatures from 55 to 70° C.:

| Ingredient | Amount |
|---|---|
| Parmesan, Cheddar, Swiss Cheese Flavors | 5.40 g |
| Garlic Powder | 5.40 g |
| Salt & Vinegar Flavor | 3.60 g |
| Whey | 18.00 g |

The food product prepared by this procedure had a pH between 4 and 7, and fully expanded within 15 seconds in oil heated at 400° F. (204° C.) and within 25 seconds in oil heated at 350° F. Furthermore, the flavored pellets were fully expanded within 45 seconds by hot air, wherein hot air temperature was at 375-400° F.

### EXAMPLE 22

Following the same procedures as described in the previous examples, a puffable (expandable) food product of the present invention was prepared with inclusion of the following ingredients:

A mixture of 126 grams of potato starch, 36 grams of corn starch, 18 grams of tapioca starch, 248 cc of heated water, and the following ingredients were prepared by using a jacket mixer for 4 to 6 minutes at water temperatures from 55 to 70° C.:

| Ingredient | Amount |
|---|---|
| Natural Sweet Potato Flavor | 13.50 g |
| Sugar | 41.40 g |
| Salt | 3.60 g |

The food product prepared by this procedure had a pH between 4 and 7, and fully expanded within 15 seconds in oil heated at 400° F. (204° C.) and within 25 seconds in oil heated at 350° F. Furthermore, the flavored pellets were fully expanded within 45 seconds by hot air, wherein hot air temperature was at 375-400° F.

### EXAMPLE 23

Following the same procedures as described in the previous examples, a puffable (expandable) food product of the present invention was prepared with inclusion of the following ingredients:

A mixture of 180 grams of potato starch, 230 cc of heated water, and the following ingredients were prepared by using a jacket mixer for 4 to 6 minutes at water temperatures from 55 to 65° C.:

| Ingredient | Amount |
|---|---|
| Sour Cream & Onion Flavor | 9.00 g |
| Salt & Vinegar Potato Flavor | 10.62 g |
| Salt | 3.60 g |
| Whey | 27.00 g |

The food product prepared by this procedure had a pH between 4 and 7, and fully expanded within 15 seconds in oil heated at 400° F. (204° C.) and within 25 seconds in oil heated at 350° F. Furthermore, the flavored pellets were fully expanded within 45 seconds by hot air, wherein hot air temperature was at 375-400° F.

### EXAMPLE 24

Following the same procedures as described in the previous examples, a puffable (expandable) food product of the present invention was prepared with inclusion of the following ingredients:

A mixture of 180 grams of potato starch, 248.50 cc heated water, and the following ingredients were prepared by using a jacket mixer for 4 to 6 minutes at water temperatures from 55 to 65° C.:

| Ingredient | Amount |
|---|---|
| Bacon Flavor | 9.00 g |
| Sugar | 10.80 g |
| Salt | 14.40 g |

The food product prepared by this procedure had a pH between 4 and 7, and fully expanded within 15 seconds in oil heated at 400° F. (204° C.) and within 25 seconds in oil heated at 350° F. Furthermore, the flavored potato pellets were fully expanded within 45 seconds by hot air, wherein hot air temperature was at 375-400° F.

### EXAMPLE 25

A puffable (expandable) food product of the present invention was prepared with inclusion of the following ingredients:

A mixture of 180 grams of potato starch, 207 cc of heated water, and the following ingredients were prepared by using a jacket mixer for 4 to 6 minutes at water temperatures from 55 to 65° C.:

| Ingredient | Amount |
|---|---|
| Sour Cream & Onion Flavor | 27 g |
| Sugar | 10.80 g |
| Salt | 14.40 g |

The sheets formed from the mixture of potato starch and water, wherein the matrix of the potato starch included the sour cream and onion seasoning, were steamed and cooled and then pre-dried die cut to form 1.5 cm×1.5 cm square shaped pieces. Then, after these pellets were dried to obtain a 13%±1.5% moisture content, the size of these square shaped pellets shrank to 1.2-1.4 cm×1.2-1.4 cm.

Seventy of these dried pellets were placed in a standard microwaveable popcorn bag and microwaved using a Westinghouse 850W microwave. After approximately 5-10 seconds, a popping sound was heard. As the puffable pellets expanded, the popcorn bag inflated as the moisture from the pellets inflated the bag. After about 50 seconds, the microwaveable bag was fully inflated. The bag was opened following the same procedures used when opening well known popcorn bags and unique, uniformly puffed products were obtained. The final puffed products had outstanding microwaveability characteristics including improved mouth feel and texture in addition to the added taste of sour cream and onion.

### EXAMPLE 26

A puffable food product of the present invention including sour cream and onion seasoning was prepared in the same manner as the procedure described in Example 25. The sheets were formed from the mixture of potato starch and water, wherein the matrix of the potato starch included the barbeque or sour cream and onion seasoning, were steamed, cooled and then pre-dried die cut to form square shapes. Then, after these pellets were dried to obtain a 13%±1.5% moisture content, the size of these square shaped pellets shrank to 1.2-1.4 cm×1.2-1.4 cm.

Forty of these dried pellets were then placed in a microwaveable bag, sealed, and microwaved using a General Electric 600W microwave. After approximately 5-10 seconds, a popping sound was heard. As the puffable pellets expanded, not only was a puffing sound heard, but the popcorn bag inflated as the moisture from the pellets lifted up the bag. Further, after about 55 seconds, the popping sound ceased and the microwaveable bag was fully inflated. The bag was opened following the same procedures used when opening well known popcorn bags and unique, uniformly puffed products were obtained. The final puffed products had outstanding microwaveability characteristics including improved mouth feel and texture in addition to the added sour cream and onion taste.

The food product prepared by this procedure had a pH between 4 and 7 and fully expanded within 15 seconds in oil heated at 400° F. (204° C.) and within 25 seconds in oil heated at 350° F. Furthermore, the flavored potato pellets were fully expanded within 45 seconds by hot air, wherein hot air temperature was at 375-400° F.

Nutraceutical Enhancements

It is contemplated that one or more from the following ingredients can be mixed with starch and water during the initial mixing phase. The purpose of adding one or more from the following ingredients during the initial mixing phase is to provide for more nutritious and healthy snacking options to the consumers. Specifically, adding such ingredients creates fat free nutritious snacks, or fat free or low fat nutritious snacks if such pellets were expanded by hot air and microwave.

The added ingredients include, vitamin and minerals, (including A, B1, B2, B6, B12, C, D3, E, folic acid, niacinamide, iron, zinc), calcium, herbs including natural herbs used for Chinese herbal medicine, and other healthy and nutritional ingredients. An anticipated level in non fat snack foods is approximately 0.2 grams per 100 gram starch.

| Nutraceutical | Amount | |
|---|---|---|
| Vitamin A | 500 | IU |
| Vitamin D₃ | 40 | |
| Vitamin E | 3 | mg |
| Vitamin C | 6 | mg |
| Vitamin B₃ | 5 | mg |
| Vitamin B₆ | 0.5 | mg |
| Vitamin B₂ | 0.425 | mg |
| Vitamin B₁ | 0.375 | mg |
| Vitamin B₁₂ | 0.0015 | mg |
| Iron | 4.5 | mg |
| Zinc | 3.75 | mg |
| Folate | 0.1 | mg |

### EXAMPLE 27

In addition to the formulations disclosed in the previous examples 17-18, and 21-24, 0.02% of Vitamins and Mineral mixture, by weight was added to each recipe during the initial mixing phase. The addition of such ingredient did not impede the product expansion. When the pellets were expanded using a hot air popper, the expanded products are not only nutritious but are either fat free or low fat healthy snacks.

The food product prepared by this procedure had a pH of between 4 to 7, and fully expands within 15 seconds in oil heated at 400° F. (204° C.) and within 25 seconds in oil heated at 350° F. Furthermore, the flavored potato pellets were fully expanded within 45 seconds by hot air, wherein hot air temperature was at 375-400° F.

A further processing is available for microwaveable puffable food products. That is, the starch, such as potato starch and water mixture of any of the preceding flavored Examples can be formed as set forth. Specifically, a potato starch and water mixture can be combined with sour cream and onion flavoring, as well as salt, sugar or whey as in the Examples. The combination is mixed well and processed as set forth above to form pellets. 25 g of the pellets were then coated with 2 g of sour cream and onion flavored powder and 5 g vegetable oil. The pellets were thoroughly coated, and placed in a microwave bag, as known in the art. The microwave bag was exposed to 650 to 800W microwaves for approximately 25 seconds, or 900-1000W microwaves for approximately 20 seconds for complete puffing of the flavored and coated pellets.

Although the flavoring is set forth as sour cream and onion, it is believed that any of the available flavorings can be used as the internal and external flavorings. That is, the pellet can be formed with a first internal flavoring retained within the starch matrix, and a second external flavoring as a coating formed on the surface of the pellet, wherein the first and second flavorings can be the same or different. The second (external) flavoring can be retained by employing an oil to adhere the flavoring to the pellet. The coated, flavored pellets can then be stored in a microwave bag for selective puffing. Typically, the second (external) flavoring is not chemically bonded in the starch matrix, but is rather mechanically retained relative to the pellet.

Thus, the present invention contemplates the formation of a starch, salt and carbohydrate mixture, as in the present examples, wherein the resulting gelatinized product is subsequently coated or enrobed with a flavoring typically such flavoring can be accomplished by employing a flavoring in an oil carrier, wherein the oil is applied to the gelatinized product. The oil can be applied by any of a variety of methods including but not limited to spraying, misting or dipping as well as immersion and curtains.

Thus, while there have been described what are presently believed to be the preferred embodiments of the present invention, those skilled in the art will realize that other and further embodiments can be made without departing from the spirit and scope of the invention, and it is intended to include all such further modifications and changes as come within the true scope of the invention.

1. A puffable food product comprising:
(a) a gelatinized food starch having from about 7.5% to 19% by weight moisture content, a pH between 4 and 7, whey, and less than about 0.1% protein, the dough being free of maltodextrin and leavening.

2. The puffable food product of claim 1, wherein the whey is a powdered whey.

3. The puffable food product of claim 1, wherein the gelatinized food starch is potato starch.

4. The puffable food product of claim 1, wherein the pH is between 5.5 and 6.5.

5. The puffable food product of claim 1, further comprising an edible acid.

6. The puffable food product of claim 1, further comprising at least one of a flavoring and a seasoning selected to reduce an air pocket size in the puffed food product.

7. The puffable food product of claim 1, wherein the pH and the starch are selected to fully expand the food product within 15 seconds in oil at a temperature of 400° F.

8. The puffable food product of claim 1, wherein the pH and the starch are selected to fully expand the food product within 45 seconds in air at a temperature of between 375° F. and 400° F.

9. The puffable food product of claim 1, further comprising a nutraceutical.

10. A mixture for forming a puffable food product, the mixture comprising:
(a) a fully ungelatinized food starch;
(b) between about 0.1% to 5% whey;
(c) a protein content less than 0.1%; and
(d) between 0.1 to 5% weight sugar.

11. The mixture of claim 10, further comprising between 0.1 to 5% weight salt.

12. The mixture of claim 10, wherein the whey is in the form of a powder.

13. The mixture of claim 10, being free of maltodextrin.

14. The mixture of claim 10, further comprising one of a flavoring and a seasoning selected to reduce a volume of an air pocket in a resulting puffed food product.

15. A dough for gelatinization to form a puffable food product, the dough comprising:
(a) a partially gelatinized potato starch;
(b) between 0.1 to 5% weight whey; and
(c) an edible acid homogeneously distributed throughout the dough to provide a dough pH less than 7, the dough having less than 1% protein by weight.

16. The dough of claim 15, further comprising one of a flavoring and a seasoning selected to reduce a volume of an air pocket in a resulting puffed food product.

17. The dough of claim 15, further comprising between 0.1 and 5% salt.

18. The dough of claim 15, further comprising between 0.1 and 5% sugar.

19. The dough of claim 15, further comprising a nutraceutical.

20. A puffable food product comprising:
(a) fully gelatinized food starch having less than 0.1% protein by weight and a pH less than 6.5.

21. The puffable food product of claim 20, wherein the food starch is potato starch.

22. The puffable food product of claim 20, further being free of maltodextrin.

23. The puffable food product of claim 20, further comprising a nutraceutical.

24. The puffable food product of claim 20, further comprising one of a flavoring and a seasoning selected to reduce a volume of an air pocket in the puffed food product.

25. A mixture for forming a puffable food product, the dough comprising:
(a) a gelatinizable food starch mixture having less than 0.1% protein by weight, and a pH less than 6.5, and a fully ungelatinized starch.

26. The mixture of claim 25, wherein the fully ungelatinized starch consists essentially of potato starch.

27. The mixture of claim 25, further comprising one of a flavoring and a seasoning selected to reduce a volume of an air pocket in the puffed food product.

28. The mixture of claim 25, further being free of maltodextrin.

29. The mixture of claim 25, further comprising whey.

30. A method for preparing a puffable food product comprising:
(a) mixing a gelatinizable starch containing only trace amounts of protein with water at a temperature and for a time sufficient to at least partially gelatinize the starch;
(b) forming the mixture from step (a) into a sheet and subjecting the sheet to a steam treatment to completely gelatinize the starch;
(c) cooling the gelatinized starch to below ambient temperature;
(d) shaping the sheet from step (c) into pellets; and
(e) drying the pellets to a moisture content in the range of from about 7.5% to about 19% by weight of the mixture.

31. The method of claim 30, wherein the moisture content of the pellets is from about 8% to about 16% by weight of the pellets.

32. The method of claim 30, wherein the moisture content of the pellets is from about 1-% to about 15% by weight of the pellets.

33. The method of claim 30, wherein the moisture content of the pellets is from about 11% to about 14% by weight of the pellets.

34. The method of claim 30, wherein the moisture content of the pellets is about 12%.

35. The method of claim 30, wherein the starch contains less than 0.1% by weight protein.

36. The method of claim 30, wherein the starch is obtained from a source selected from the group consisting of potatoes, mung beans, wheat, corn, soy beans, rice, rice powders, tapioca, bean starches, and combinations thereof.

37. The method of claim 30, wherein the starch is 100% potato starch.

38. The method of claim 30, which further comprises adding a natural or artificial seasoning to the starch prior to step (a).

39. The method of claim 38, wherein the seasoning is selected from the group consisting of salt, vinegar, barbecue seasoning, nacho seasoning, sour cream and onion seasoning, sweet and sour seasoning, sweet seasoning, hot seasoning, spice seasoning, chicken flavor seasoning, savory flavor seasoning, fruit seasonings, citrus seasoning, vegetable seasonings, MSG, HVP, Yeast Autolysates, flavor reaction products and other including dairy, vegetable and fruit flavored seasonings.

40. The method of claim 30, wherein the pellets are shaped by die cutting.

41. The method of claim 40, wherein the pellets have a square shape.

42. The method of claim 40, wherein the pellets have a round shape.

43. A puffable food product prepared by the method of claim 30.

44. A puffable food product prepared by the method of claim 31.

45. A puffable food product prepared by the method of claim 32.

46. A puffable food product prepared by the method of claim 33.

47. A puffable food product prepared by the method of claim 34.

48. A puffable food product prepared by the method of claim 47 wherein the starch is potato starch.

49. A method for preparing an edible food comprising heating the pellets of claim 43 at a temperature and for a time sufficient to expand the pellets at least two-fold.

50. A method for forming a puffable food product particles, comprising:
(a) partially gelatinizing a mixture of potato starch and water, the mixture having less than 1% protein by weight;
(b) forming the partially gelatinized mixture into a sheet;
(c) fully gelatinizing the sheet to an initial moisture content;
(d) cooling the fully gelatinized sheet below room temperature to a moisture content below the initial moisture content and above 18%; and
(e) subdividing the sheet to form a plurality of particles.

51. A puffable food product comprising:
(a) fully gelatinized food starch having a first flavoring disposed within the gelatinized food starch and a second flavoring on a surface of the gelatinized food starch.

52. The puffable food product of claim 51, further comprising less than 0.1% protein by weight and a pH less than 6.5.

53. The puffable food product of claim 51, wherein the first flavoring and the second flavoring are different.

54. The puffable food product of claim 51, wherein the first flavoring and the second flavoring are the same.

55. A puffable food product comprising:
(a) a gelatinized mixture of starch, salt and a carbohydrate in the form of a body; and
(b) a flavoring on an external surface of the body.

56. The puffable food product of claim 55, wherein the flavoring is mixed with an oil.
